(19) United States
(12) Patent Application Publication
(10) Pub. No.: US 2015/0280196 A1
(43) Pub. Date: Oct. 1, 2015

(54) SEPARATOR, AND SECONDARY BATTERY

(71) Applicant: DAIKIN INDUSTRIES, LTD., Osaka-shi, Osaka (JP)

(72) Inventors: Toshiki Ichisaka, Settsu-shi (JP); Takahiro Kitahara, Settsu-shi (JP)

(73) Assignee: DAIKIN INDUSTRIES, LTD., Osaka-Shi, Osaka (JP)

(21) Appl. No.: 14/428,513

(22) PCT Filed: Oct. 22, 2013
(86) PCT No.: PCT/JP2013/078529

§ 371 Date: Mar. 16, 2015

(30) Foreign Application Priority Data
Oct. 22, 2012 (JP) 2012-233073

(51) Int. Cl. H01M 2/16

(52) U.S. Cl. CPC H01M 2/1686; H01M 2/1653

(57) ABSTRACT

The present invention aims to provide a separator having a high ion conductivity and excellent durability, and a secondary battery. The present invention relates to a separator including a layer that includes a fluoropolymer including a polymer unit based on vinylidene fluoride and a polymer unit based on tetrafluoroethylene, and a porous membrane. The fluoropolymer includes 80.0 to 89.0 mol % of the polymer unit based on vinylidene fluoride in all the polymer units, and has a weight average molecular weight of 50000 to 2000000.

### TECHNICAL FIELD

The present invention relates to a separator and a secondary battery. The present invention specifically relates to a separator suitable for secondary batteries such as lithium secondary batteries and a secondary battery comprising the same.

### BACKGROUND ART

Non-aqueous secondary batteries typified by lithium secondary batteries have a high energy density, and are widely used as main power supply of portable electronic devices such as mobile phones and laptop computers. These batteries are also expected to serve as one of the decisive factors in dealing with the global warming; for example, they are used in electric vehicles (EV). Lithium secondary batteries are required to have a higher energy density and much improved battery characteristics. In addition, the guarantee of safety thereof is one technical issue.

The basic structure of a lithium secondary battery comprises a non-aqueous electrolyte and optionally a separator each disposed between a positive electrode and a negative electrode. The separator exists between the positive electrode and the negative electrode to prevent a contact of the active materials of the electrodes, and allows the electrolyte to pass through the pores thereof to provide a channel for ionic conduction between the electrodes.

Traditional separators usually used are microporous polyolefin films formed from polyethylene, polypropylene, or the like material. The researchers have recently studied the way of improving the characteristics and the safety of batteries by improving the performance of the separator.

In order to favorably prevent the oxidative degradation of a separator to improve the cycle characteristics of batteries and to sufficiently prevent the resulting battery from swelling due to gas, Patent Literature 1 discloses a separator for non-aqueous secondary batteries comprising a polyolefin microporous membrane, for example, and a 1- to 500-nm-thick fluorine-based compound layer disposed on the surface thereof.

Patent Literature 2 discloses a separator for non-aqueous electrolyte secondary batteries comprising a shutdown layer and a heat-resistant porous layer. The heat-resistant porous layer has a dot-like, line-like, mesh-like, or porous-film-shaped spacer on the surface thereof opposite the shutdown layer (see claim 1). Specific examples of the spacer include those produced by applying a suspension of, for example, polypropylene, polyethylene, or a tetrafluoroethylene-hexafluoropropylene copolymer to the surface of the heat-resistant porous layer and then drying the suspension (see Examples 1 to 3).

Traditional separators comprising a polyolefin film have ignitability. Further, when a battery is driven by a high voltage or at high temperature, the positive electrode side of the separator degenerates and stained.

Patent Literature 3 then discloses a separator coated with an electrolyte-retaining layer. This separator is produced by dissolving a copolymer of vinylidene fluoride, tetrafluoroethylene, and hexafluoropropylene, or a mixture thereof, into THF, applying the copolymer or the mixture to a polyethylene separator, and drying the applied copolymer or the mixture (see Examples 1 to 6).

### CITATION LIST

### Patent Literature

### Patent Literature 1: JP 2011-108515 A

### Patent Literature 2: JP 2002-151044 A

### Patent Literature 3: WO 2011/096564

### SUMMARY OF INVENTION

### Technical Problem

Still, a separator having further improved performance is expected.

The present invention is devised in the aforementioned situation, and aims to provide a separator having a high ion conductivity and excellent durability, and a secondary battery.

### Solution to Problem

The inventors have found out the following. Specifically, a separator that comprises a layer comprising a fluoropolymer that includes a polymer unit based on vinylidene fluoride and a polymer unit based on tetrafluoroethylene and a porous membrane can have a high ion conductivity and low electrolyte swellability if the fluoropolymer includes the polymer unit based on vinylidene fluoride in an amount within a specific range and the fluoropolymer has a weight average molecular weight within a specific range. Thereby, the inventors have completed the present invention.

Specifically, the present invention relates to a separator comprising a layer comprising a fluoropolymer that includes a polymer unit based on vinylidene fluoride and a polymer unit based on tetrafluoroethylene; and a porous membrane, the fluoropolymer including 80.0 to 89.0 mol % of the polymer unit based on vinylidene fluoride in all the polymer units, and the fluoropolymer having a weight average molecular weight of 50000 to 2000000.

The porous membrane preferably comprises at least one resin selected from the group consisting of polyethylene, polypropylene, and polyimide.

The layer comprising the fluoropolymer preferably further comprises polyvinylidene fluoride.

The present invention also relates to a secondary battery comprising the above separator, a positive electrode, a negative electrode, and a non-aqueous electrolyte.

### Advantageous Effects of Invention

The separator of the present invention has both high ion conductivity and low electrolyte swellability. A secondary battery comprising the separator of the present invention has excellent characteristics, including a long cycle life and high durability.

### DESCRIPTION OF EMBODIMENTS

The present invention will be described in detail below.

The separator of the present invention comprises a layer comprising a fluoropolymer (hereinafter, also referred to as a fluoropolymer layer) that includes a polymer unit based on vinylidene fluoride (VdF) (hereinafter also referred to as a “VdF unit”) and a polymer unit based on tetrafluoroethylene (TFE) (hereinafter also referred to as a “TFE unit”), and a porous membrane.

The fluoropolymer includes the VdF unit and the TFE unit, and the amount of the VdF unit is 80.0 to 89.0 mol % in all the polymer units.

The fluoropolymer including less than 80.0 mol % of the VdF unit tends to have too high swellability in an electrolyte, resulting in poor long-term durability. The fluoropolymer including more than 89.0 mol % thereof tends to have a poor ion conductivity.

The fluoropolymer preferably includes 80.5 mol % or more, and more preferably 82.0 mol % or more, of the VdF unit in all the polymer units. The fluoropolymer including 82.0 mol % or more thereof can have much lower swellability in an electrolyte, resulting in better long-term durability.

The fluoropolymer still more preferably includes 82.5 mol % or more of the VdF unit in all the polymer units. The fluoropolymer also preferably includes 88.9 mol % or less, and more preferably 88.8 mol % or less, of the VdF unit in all the polymer units.

The composition of the fluoropolymer can be determined using an NMR analyzing device.

In addition to the VdF unit and the polymer unit based on TFE, the fluoropolymer may further include a polymer unit based on a monomer copolymerizable with VdF and TFE. Although the copolymer of VdF and TFE is enough to achieve the effects of the present invention, a monomer copolymerizable with VdF and TFE may be copolymerized with these units to the extent that the additional unit does not impair the excellent swellability in a nonaqueous electrolyte of the copolymer. This further improves the adhesion property.

The amount of the polymer unit based on a monomer copolymerizable with VdF and TFE is preferably less than 3.0 mol % in all the polymer units in the fluoropolymer. Not smaller than 3.0 mol % of this polymer unit usually tends to significantly deteriorate the crystallinity of the copolymer of VdF and TFE, resulting in poor resistance to 1.5 swelling in a nonaqueous electrolyte.

Examples of the monomer copolymerizable with VdF and TFE include: unsaturated dibasic acid monoesters as disclosed in JP H06-172452 A (e.g., monomethyl maleate, monomethyl citraconate, monoethyl citraconate); maleic acid; maleic anhydride; vinylene carbonate; and compounds as disclosed in JP H07-201316 A having a hydrophilic polar group, such as —SO₃M, —OSO₃M, —COOM, and —OPO₃M (where M represents an alkali metal), amine polar groups (e.g., —NHR^{a} and —NR^{b}R^{c} where R^{a}, R^{b}, and R^{c} each represent an alkyl group), amide groups (e.g., —CO—NRR′ where R and R′ may be the same as or different from each other and each represent a hydrogen atom or an alkyl group optionally having a substituent), and amide bonds (e.g., —CO—NR″— where R″ represents a hydrogen atom, an alkyl group optionally having a substituent, or a phenyl group optionally having a substituent).

In the compounds having an amide group, the amide group is a group represented by —CO—NRR′. R and R′ may be the same as or different from each other, and each represent a hydrogen atom or an alkyl group optionally having a substituent. If R and R′ are each an alkyl group, it may be linear, cyclic, or branched. The alkyl group preferably has 1 to 30 carbon atoms, and more preferably has 1 to 20 carbon atoms. The substituent may be a halogen atom, a C1-C30 alkoxy group, or a C6-C30 aryl group, for example.

The compound having an amide group may be any compound having one or more polymerizable carbon-carbon double bonds and one or more amide groups in a molecule. It is preferably a monomer which has one polymerizable carbon-carbon double bond and one amide group in a molecule and which is represented by the formula (1):

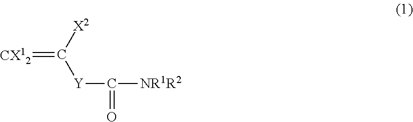

wherein X¹s may be the same as or different from each other, and each represent a hydrogen atom or an alkyl group optionally having a substituent; X² represent a hydrogen atom or an alkyl group optionally having a substituent; Y represents a single bond or an alkylene group optionally having a substituent; and R¹ and R² may be the same as or different from each other, and each represent a hydrogen atom or an alkyl group optionally having a substituent. In the formula (1), each X¹ represents a hydrogen atom or an alkyl group. In the formula (1), two X¹s may be the same as or different from each other. The alkyl group may or may not have a substituent. The alkyl group may be linear, cyclic, or branched. The alkyl group may be the same as that mentioned for R and R′.

The X¹s each preferably represents a hydrogen atom or a halogen atom, and particularly preferably a hydrogen atom.

In the formula (1), X² represents a hydrogen atom or an alkyl group. The alkyl group may or may not have a substituent. The alkyl group may be linear, cyclic, or branched. The alkyl group may be the same as that mentioned for X¹. The X² particularly preferably represents a hydrogen atom or a methyl group.

In the formula (1), Y represents a single bond or an alkylene group. The alkylene group may or may not have a substituent. The alkylene group may be linear, cyclic, or branched. The alkylene group preferably has 1 to 30 carbon atoms, and more preferably 1 to 25 carbon atoms.

The substituent may be the same as those mentioned for X′.

In the formula (1), R¹ and R² each represent a hydrogen atom or an alkyl group. R¹ and R² may be the same as or different from each other. The alkyl group may or may not have a substituent. The alkyl group may be linear, cyclic, or branched. The alkyl group may be the same as that mentioned for X¹. R¹ and R² each preferably represent a hydrogen atom or a halogen atom, and particularly preferably a hydrogen atom.

The compound having an amide group is particularly preferably a (meth)acrylamide species represented by the formula (2):

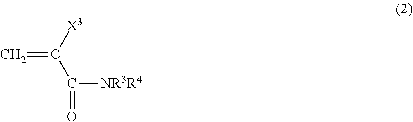

wherein X³ represents a hydrogen atom or a methyl group; and R³ and R⁴ may be the same as or different from each other, and each represent a hydrogen atom or an alkyl group optionally having a substituent. In the formula (2), specific examples of R³ and R⁴ include the same as those mentioned for R¹ and R² in the formula (1).

Examples of the (meth)acrylamide species include (meth)acrylamide and derivatives thereof. Specific examples thereof include (meth)acrylamide, N-methyl (meth)acrylamide, N-isopropyl(meth)acrylamide, N-tert-butyl (meth)acrylamide, N-phenyl(meth)acrylamide, N-methoxymethyl (meth)acrylamide, N-butoxymethyl (meth)acrylamide, 4-acryloylmorpholine, diacetone(meth)acrylamide, N,N-dimethyl (meth)acrylamide, N,N-diethyl (meth)acrylamide, and 2-(meth)acrylamido-2-methylpropane sulfonic acid. Particularly preferred is N-tert-butyl acrylamide.

In the compound having an amide bond, the amide bond is a bond represented by —CO—NR″—, or may be a bond represented by —CO—NR″—CO—. R″ represents a hydrogen atom, an alkyl group optionally having a substituent, or a phenyl group optionally having a substituent. The alkyl group and the substituent may be the same as those mentioned for R in the compound having an amide group. Examples of the compound having an amide bond include N-vinyl acetamide and its derivatives such as N-vinyl acetamide and N-methyl-N-vinyl acetamide; and maleimide and its derivatives such as maleimide, N-butyl maleimide, and N-phenyl maleimide. Particularly preferred is N-vinyl acetamide.

Examples of the monomer copolymerizable with VdF and TFE also include CH₂═CH—CH₂—Y, CH₂═C(CH₃)—CH₂—Y, CH₂═CH—CH₂—O—CO—CH(CH₂COOR^{d})—Y, CH₂═CH—CH₂—O—CH₂—CH(OH)—CH₂—Y, CH₂═C(CH₃)—CO—O—CH₂—CH₂—CH₂—Y, CH₂—CH—CO—O—CH₂—CH₂—Y, and CH₂═CHCO—NH—C(CH₃)₂—CH₂—Y, wherein Y represents a hydrophilic polar group and R^{d} represents an alkyl group. Examples thereof further include hydroxylated allyl ether monomers such as CH₂═CH—CH₂—O—(CH₂)ₙ—OH (3≦n≦8),

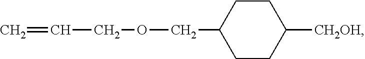

Hydroxylated allyl ether monomers such as CH₂═CH—CH₂—O—(CH₂—CH₂—O)ₙ—H (1≦n≦14), and CH₂═CH—CH₂—O—(CH₂—CH(CH₃)—O)ₙ—H (1≦n≦14); and allyl ether or ester monomers carboxylated and/or substituted with (CF₂)ₙ—CF₃ (3≦n≦8), such as CH₂═CH—CH₂—O—CO—C₂H₄—COOH, CH₂═CH—CH₂—O—CO—C₅H₁₀—COOH, CH₂═CH—CH₂—O—C₂H₄—(CF₂)ₙCF₃, CH₂═CH—CH₂—CO—O—C₂H₄—(CF₂)ₙCF₃, and CH₂═C(CH₃)—CO—O—CH₂—CF₃.

The previous studies suggest that compounds other than those having any of the above polar groups can also slightly reduce the crystallinity of the copolymer of vinylidene fluoride and tetrafluoroethylene to make the material flexible, thereby improving the adhesion property. This enables the use of unsaturated hydrocarbon monomers (CH₂═CHR, R represents a hydrogen atom, an alkyl group, or a halogen (e.g., Cl)) such as ethylene and propylene; and fluoromonomers such as chlorotrifluoroethylene, hexafluoropropylene (HFP), hexafluoroisobutene, 2,3,3,3-tetrafluoropropene, CF₂═CF—O—CₙF₂ₙ₊₁ (n is an integer of 1 or greater), CH₂═CF—CₙF₂ₙ₊₁ (n is an integer of 1 or greater), CH₂═CF—(CF₂CF₂)—H (n is an integer of 1 or greater), and CF₂═CF—O—(CF₂CF(CF₃)O)ₘ—CₙF₂ₙ₊₁ (m and n are each an integer of 1 or greater).

In addition, fluorine-containing ethylenic monomers having at least one functional group can also be used. Such monomers are represented by the formula:

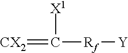

wherein Y represents —CH₂OH, —COOH, a carboxylic acid salt, a carboxy ester group, or an epoxy group; X and X¹ may be the same as or different from each other, and each represent a hydrogen atom or a fluorine atom; and R_{f} represents a C1-C40 divalent fluoroalkylene group or a C1-C40 divalent fluoroalkylene group having an ether bond. Copolymerization with one or more of these monomers can further improve the adhesion property and provide good charge and discharge cycle characteristics even after a repetition of charge and discharge.

In order to give good flexibility and chemical resistance, hexafluoropropylene and 2,3,3,3-tetrafluoropropene are particularly preferred among these monomers.

The fluoropolymer thus may include, in addition to the VdF unit and the TFE unit, any other polymer units. Still, the fluoropolymer more preferably consists only of the VdF unit and the TFE unit.

The fluoropolymer preferably has a weight average molecular weight (polystyrene equivalent) of 50000 to 2000000. It is preferably 80000 to 1700000, more preferably 100000 to 1500000, still more preferably 200000 to 1400000, and particularly preferably 300000 to 1300000. The lower limit of the weight average molecular weight of the fluoropolymer is particularly preferably higher than 500000, and most preferably 600000.

The weight average molecular weight can be determined by gel permeation chromatography (GPC) using N,N-dimethylformamide as a solvent at 50° C.

The fluoropolymer preferably has a number average molecular weight (polystyrene equivalent) of 10000 to 1400000. It is preferably 16000 to 1200000, more preferably 20000 to 1000000, still more preferably 40000 to 800000, and particularly preferably 80000 to 700000.

The number average molecular weight can be determined by gel permeation chromatography (GPC) using N,N-dimethylformamide as a solvent at 50° C.

The fluoropolymer can be prepared by, for example, appropriately mixing VdF and TFE monomers as polymer units and additives (e.g., a polymerization initiator), and then suspension polymerizing, emulsion polymerizing, or solution polymerizing the monomers. For easy post-treatments, for example, aqueous suspension or emulsion polymerization is preferred.

In the polymerization, a polymerization initiator, a surfactant, a chain transfer agent, and a solvent can be used, and they may be conventionally known ones.

The polymerization initiator can be an oil-soluble radical polymerization initiator or a water-soluble radical polymerization initiator.

The oil-soluble radical polymerization initiator may be a known oil-soluble peroxide. Representative examples thereof include: dialkyl peroxycarbonates such as diisopropyl peroxydicarbonate, di-n-propyl peroxydicarbonate, and di-sec-butyl peroxydicarbonate; peroxyesters such as t-butyl peroxyisobutyrate and t-butyl peroxypivalate; dialkyl peroxides such as di-t-butyl peroxide; and di[perfluoro(or fluorochloro)acyl]peroxides such as di(ω-hydro-dodecafluoroheptanoyl)peroxide, di(ω-hydro-tetradecafluoroheptanoyl)peroxide, di(ω-hydro-hexadecafluorononanoyl)peroxide, di(perfluorobutylyl)peroxide, di(perfluorovaleryl)peroxide, di(perfluorohexanoyl)peroxide, di(perfluoroheptanoyl)peroxide, di(perfluorooctanoyl)peroxide, di(perfluorononanoyl)peroxide, di(ω-chloro-hexafluorobutylyl)peroxide, di(ω-chloro-decafluorohexanoyl)peroxide, di(ω-chloro-tetradecafluorooctanoyl)peroxide, ω-hydro-dodecafluoroheptanoyl-ω-hydrohexadecafluorononanoyl-peroxide, ω-chloro-hexafluorobutylyl-ω-chloro-decafluorohexanoyl-peroxide, ω-hydrododecafluoroheptanoyl-perfluorobutylyl-peroxide, di(dichloropentafluorobutanoyl)peroxide, di(trichlorooctafluorohexanoyl)peroxide, di(tetrachloroundecafluorooctanoyl)peroxide, di(pentachlorotetradecafluorodecanoyl)peroxide, and di(undecachlorodotriacontafluorodocosanoyl)peroxide.

The water-soluble radical polymerization initiator may be a known water-soluble peroxide. Examples thereof include ammonium salts, potassium salts, and sodium salts of persulfuric acid, perboric acid, perchloric acid, perphosphoric acid, and percarbonic acid, t-butyl permaleate, and t-butyl hydroperoxide. These peroxides may be used in combination with a reducing agent such as a sulfite or a sulfurous acid salt. The amount of the reducing agent may be 0.1 to 20 times the amount of the peroxide.

The surfactant may be a known surfactant, and examples thereof include nonionic surfactants, anionic surfactants, and cationic surfactants. Preferred are fluorine-containing anionic surfactants, and more preferred are C4-C20 linear or branched fluorine-containing anionic surfactants which may have an ether bond (in other words, which may have an oxygen atom between carbon atoms). The amount of the surfactant (for the amount of water as a polymerization medium) is preferably 50 to 5000 ppm.

Examples of the chain transfer agent include hydrocarbons such as ethane, isopentane, n-hexane, and cyclohexane; aromatic compounds such as toluene and xylene; ketones such as acetone; acetates such as ethyl acetate and butyl acetate; alcohols such as methanol and ethanol; mercaptans such as methyl mercaptan; and halogenated hydrocarbons such as carbon tetrachloride, chloroform, methylene chloride, and methyl chloride. The amount of the chain transfer agent may be adjusted in accordance with the chain transfer constant thereof, and it is usually 0.01 to 20% by mass for the amount of the polymerization solvent.

The solvent may be water or a solvent mixture of water and an alcohol, for example.

In the suspension polymerization, a fluorine-containing solvent may be used in combination with water. Examples of the fluorine-containing solvent include hydrochlorofluoroalkanes such as CH₃CClF₂, CH₃CCl₂F, CF₃CF₂CCl₂H, and CF₂ClCF₂CFHCl; chlorofluoroalkanes such as CF₂ClCFClCF₂CF₃ and CF₃CFClCFClCF₃; and perfluoroalkanes such as perfluorocyclobutane, CF₃CF₂CF₂CF₃, CF₃CF₂CF₂CF₂CF₃, and CF₃CF₂CF₂CF₂CF₂CF₃. Perfluoroalkanes are preferred. For easy suspension and cost reduction, the amount of the fluorine-containing solvent is preferably 10 to 100% by mass to the amount of an aqueous medium.

The polymerization temperature is not particularly limited, and may be 0° C. to 100° C. The polymerization pressure can appropriately be determined in accordance with other polymerization conditions such as the type, amount, and vapor pressure of the solvent to be used, and the polymerization temperature. It may usually be 0 to 9.8 MPaG.

In the suspension polymerization where water is used as a dispersion medium and no fluorine solvent is used, a suspension agent such as methyl cellulose, methoxylated methyl cellulose, propoxylated methyl cellulose, hydroxyethyl cellulose, hydroxypropyl cellulose, polyvinyl alcohol, polyethylene oxide, or gelatin is added to water at a concentration of 0.005 to 1.0% by mass, and preferably 0.01 to 0.4% by mass.

The polymerization initiator in this case may be diisopropyl peroxydicarbonate, dinormalpropyl peroxydicarbonate, dinormalheptafluoropropyl peroxydicarbonate, isobutylyl peroxide, di(chlorofluoroacyl)peroxide, or di(perfluoroacyl)peroxide, for example. The amount thereof is preferably 0.1 to 5% by mass for the total amount of the monomer units (the total amount of vinylidene fluoride, the monomer(s) having an amide group, and optional monomer(s) copolymerizable with these monomers).

The degree of polymerization of the resulting polymer can be adjusted with a chain transfer agent, such as ethyl acetate, methyl acetate, acetone, ethanol, n-propanol, acetaldehyde, propylaldehyde, ethyl propionate, or carbon tetrachloride. The amount thereof is usually 0.1 to 5% by mass, and preferably 0.5 to 3% by mass, for the total amount of the monomer units.

The monomers are preferably charged in amounts satisfying the weight ratio (the total amount of the monomers):(water) of 1:1 to 1:10, and more preferably 1:2 to 1:5. The polymerization is performed at a temperature of 10° C. to 50° C. for 10 to 100 hours.

The suspension polymerization can easily provide the aforementioned fluoropolymer.

In addition to the fluoropolymer, the fluoropolymer layer may further contain any other components to the extent that the components do not deteriorate the effects of the present invention. For example, the fluoropolymer layer may further contain polyvinylidene fluoride (PVdF). The fluoropolymer layer containing PVdF in addition to the fluoropolymer can lead to an effect of reducing the swellability in an electrolyte.

The PVdF to be mixed with the fluoropolymer may be a homopolymer consisting only of a polymer unit based on VdF or may include a polymer unit based on VdF and a polymer unit based on a monomer (a) copolymerizable with the polymer unit based on VdF.

Examples of the monomer (a) include vinyl fluoride, trifluoroethylene, trifluorochloroethylene, fluoroalkyl vinyl ethers, hexafluoropropylene, 2,3,3,3-tetrafluoropropene, and propylene. Examples thereof also include: unsaturated dibasic acid monoesters as disclosed in JP H06-172452 A, such as monomethyl maleate, monomethyl citraconate, and monoethyl citraconate; vinylene carbonate; compounds as disclosed in JP H07-201316 A having a hydrophilic group (e.g., —SO₃M, —OSO₃M, —COOM, and —OPO₃M, where M represents an alkali metal, and an amine polar group (e.g., —NHR^{a} and —NR^{b}R^{c}, where R^{a}, R^{b}, and R^{c} each represent an alkyl group)), such as CH₂═CH—CH₂—Y, CH₂═C(CH₃)—CH₂—Y, CH₂═CH—CH₂—O—CO—CH(CH₂COOR^{d})—Y, CH₂═CH—CH₂—O—CH₂—CH(OH)—CH₂—Y, CH₂═C(CH₃)—CO—O—CH₂—CH₂—CH₂—Y, CH₂═CH—CO—O—CH₂—CH₂—Y, and CH₂═CHCO—NH—C(CH₃)₂—CH₂—Y, where Y represents a hydrophilic polar group, and R^{d} represents an alkyl group; maleic acid; and maleic anhydride. Examples of the copolymerizable monomer further include: hydroxylated allyl ether monomers such as CH₂═CH—CH₂—O—(CH₂)ₙ—OH (3≦n≦8),

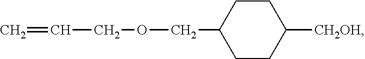

CH₂═CH—CH₂—O—(CH₂—CH₂—O)ₙ—H (1≦n≦14), and CH₂═CH—CH₂—O—(CH₂—CH(CH₃)—O)ₙ—H (1≦n≦14); allyl ether or ester monomers carboxylated and/or substituted with (CF₂)ₙ—CF₃ (3≦n≦8) such as CH₂═CH—CH₂—O—CO—C₂H₄—COOH, CH₂═CH—CH₂—O—CO—C₅H₁₀—COOH, CH₂═CH—CH₂—O—C₂H₄—CF₂)ₙCF₃, CH₂═CH—CH₂—CO—O—C₂H₄—(CF₂)ₙCF₃, and CH₂═C(CH₃)—CO—O—CH₂—CF₃. The previous studies suggest that compounds other than those having any of the above polar groups can also slightly reduce the crystallinity of the copolymer of vinylidene fluoride and tetrafluoroethylene to make the material flexible, thereby improving the adhesion property. This enables the use of unsaturated hydrocarbon monomers (CH₂═CHR, R represents a hydrogen atom, an alkyl group, or a halogen such as Cl) such as ethylene and propylene; and fluoromonomers such as chlorotrifluoroethylene, hexafluoropropylene, hexafluoroisobutene, CF₂═CF—O—CₙF₂ₙ₊₁ (n is an integer of 1 or greater), CH₂═CF—CnF₂ₙ₊₁ (n is an integer of 1 or greater), CH₂═CF—(CF₂CF₂)ₙH (n is an integer of 1 or greater), and CF₂═CF—O—(CF₂CF(CF₃)O)ₘ—CₙF₂ₙ₊₁ (m and n are each an integer of 1 or greater).

Also usable are fluorine-containing ethylenic monomers having at least one functional group represented by the formula:

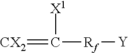

wherein Y represents —CH₂OH, —COOH, a carboxylic acid salt, a carboxy ester group, or an epoxy group; X and X¹ may be the same as or different from each other, and each represent a hydrogen atom or a fluorine atom; and R_{f} represents a C1-C40 divalent fluoroalkylene group or a C1-C40 divalent fluoroalkylene group having an ether bond. Copolymerization with one or more of these monomers can further improve the adhesion property and provide good charge and discharge cycle characteristics even after a repetition of charge and discharge.

The PVdF preferably includes 5 mol % or less, and more preferably 4.5 mol % or less, of the polymer unit based on the monomer (α) in all the polymer units.

The PVdF preferably has a weight average molecular weight (polystyrene equivalent) of 50000 to 2000000. The weight average molecular weight is more preferably 80000 to 1700000, and still more preferably 100000 to 1500000.

The weight average molecular weight can be determined by gel permeation chromatography (GPC) using N,N-dimethylformamide as a solvent at 50° C.

The PVdF preferably has a number average molecular weight (polystyrene equivalent) of 10000 to 1400000. The number average molecular weight is more preferably 16000 to 1200000, and still more preferably 20000 to 1000000.

The number average molecular weight can be determined by gel permeation chromatography (GPC) using N,N-dimethylformamide as a solvent at 50° C.

The PVdF can be produced by a conventionally known method including, for example, appropriately mixing VdF and the monomer (a) as polymer units and additives such as a polymerization initiator, and then solution polymerizing or suspension polymerizing the monomers.

The fluoropolymer layer comprising the fluoropolymer and the PVdF preferably satisfies a mass ratio (fluoropolymer)/(PVdF) of 90/10 to 10/90, and more preferably 80/20 to 15/85.

The fluoropolymer layer may comprise metal oxide particles. Any metal oxide may be used, and it is preferably one other than oxides of alkali or alkaline earth metal so as to improve the ion conductivity and the shutdown effect. Particularly preferred are aluminum oxide, silicon oxide, titanium oxide, vanadium oxide, and copper oxide, for example. The particles preferably have an average particle size of not greater than 20 μm, and more preferably not greater than 10 μm. In particular, the particles are preferably fine particles having an average particle size of not greater than 5 μm.

The metal oxide particles are particularly preferably aluminum oxide particles or silicon oxide particles having an average particle size of not greater than 5 μm because such particles have excellent ion conductivity.

The fluoropolymer layer may further comprise any other components in addition to those mentioned above. Examples of such components include polymethacrylate, polymethyl methacrylate, polyacrylonitrile, polyimide, polyamide, polyamide-imide, polycarbonate, styrene rubber, and butadiene rubber.

The fluoropolymer layer is preferably disposed on the porous membrane.

The fluoropolymer layer may be disposed on one or both of the surfaces of the porous membrane. The fluoropolymer layer may cover the whole or part of the surface where the fluoropolymer layer is disposed.

The weight of the fluoropolymer layer is preferably 0.2 to 3.0 g/m² if the fluoropolymer layer is disposed on one surface of the porous membrane. Less than 0.2 g/m² of the fluoropolymer layer may fail to give sufficient adhesion property with electrodes. More than 3.0 g/m² thereof is not preferred because the fluoropolymer layer tends to inhibit the ionic conduction, deteriorating the load characteristics of the resulting battery. If the fluoropolymer layer is disposed on both the surfaces of the porous membrane, the weight of the fluoropolymer is preferably 0.2 to 6.0 g/m².

The porous membrane herein means a substrate having pores or voids therein. Examples of such a substrate include microporous membranes, nonwoven fabric, porous sheets comprising fibrous materials (e.g., papery sheets), and combined porous membranes comprising any of these microporous membranes and porous sheets and one or more porous layers stacked thereon. The microporous membrane herein means a membrane which has many fine pores linked with each other therein and which allows gas or liquid to pass through the membrane from one side to the other side.

The material of the porous membrane may be an electrically insulating organic or inorganic material. In order to give a shutdown function to the substrate, the material of the substrate is preferably a thermoplastic resin. The shutdown function herein means a function of preventing the thermal runaway of a battery when the temperature of the battery increases. This is caused as follows: specifically, when the temperature increases, the thermoplastic resin is dissolved to close the pores of the porous substrate, thereby inhibiting the movement of ions. The thermoplastic resin is appropriately a thermoplastic resin having a melting point of lower than 200° C., and preferably polyolefin.

The porous membrane comprising polyolefin is favorably a polyolefin microporous membrane. The polyolefin microporous membrane may be a polyolefin microporous membrane which has sufficient physical properties and ion permeability and which has been used in conventional separators for non-aqueous secondary batteries. The polyolefin microporous membrane preferably contains polyethylene so as to have the aforementioned shutdown function.

In order to give heat resistance to the membrane to the extent that the membrane does not easily become torn when exposed to high temperature, the polyolefin microporous membrane preferably contains polyethylene and polypropylene. Examples of such a polyolefin microporous membrane include microporous membranes in which polyethylene and polypropylene coexist in one sheet. In order to achieve both the shutdown function and the heat resistance, such a microporous membrane preferably contains 95% by weight or more of polyethylene and 5% by weight or less of polypropylene. In order to achieve both the shutdown function and the heat resistance, the polyolefin microporous membrane also preferably has at least two or more layers, with one of the layers containing polyethylene and the other of the layers containing polypropylene.

The weight average molecular weight of polyolefin is favorably 100000 to 5000000. Polyolefin having a weight average molecular weight of lower than 100000 may have difficulty in ensuring sufficient physical properties. Polyolefin having a weight average molecular weight of larger than 5000000 may deteriorate the shutdown characteristics or may make it difficult to form a membrane.

Such a polyolefin microporous membrane can be produced by the following method, for example. Specifically, one method may include the successive steps of: (i) extruding a molten polyolefin resin through a T-die to form a sheet; (ii) crystallizing the sheet; (iii) stretching the sheet; and (iv) heat-treating the sheet, thereby providing a microporous membrane. Another method may include the successive steps of: (i) melting a polyolefin resin together with a plasticizer such as liquid paraffin, extruding the molten mixture through a T-die, and cooling the extrudate to form a sheet; (ii) stretching the sheet; (iii) extracting the plasticizer from the sheet; and (iv) heat-treating the sheet, thereby providing a microporous membrane.

The porous sheet formed from a fibrous material may be a porous sheet formed from a fibrous material such as polyesters (e.g., polyethylene terephthalate), polyolefins (e.g., polyethylene and polypropylene), and heat-resistant polymers (e.g., aromatic polyamide, polyimide, polyether sulfone, polysulfone, polyether ketone, and polyether imide), or a mixture of these fibrous materials.

The combined porous membrane may have a microporous membrane or a porous membrane formed from a fibrous material and a functional layer stacked thereon. Such a combined porous sheet is preferred in that the functional layer can give an additional function. In order to give heat resistance, for example, the functional layer may be a porous layer formed from a heat-resistant resin or a porous layer formed from a heat-resistant resin and inorganic filler. The heat-resistant resin may be one or more heat-resistant polymers selected from aromatic polyamide, polyimide, polyether sulfone, polysulfone, polyether ketone, and polyether imide. The inorganic filler may suitably be a metal oxide such as alumina or a metal hydroxide such as magnesium hydroxide. The layers may be combined as follows: for example, a functional layer is coated on a porous sheet, the layers are bonded using an adhesive, or the layers are bonded by thermo-compression.

The porous membrane in the present invention is preferably formed from at least one resin selected from the group consisting of polyethylene, polypropylene, and polyimide among the aforementioned materials.

The porous membrane in the present invention preferably has a thickness of 5 to 25 μm so as to give good physical properties and internal resistance.

The separator of the present invention can be produced by stacking the fluoropolymer layer on the porous membrane. The stacking may be achieved by any conventionally known method. Specifically, the stacking method may preferably be: a method in which the fluoropolymer and other optional components are dissolved or dispersed in a solvent, and the resulting solution or dispersion is applied to the porous membrane using a roller; a method in which the porous membrane is dipped into the solution or the dispersion; a method in which the solution or the dispersion is applied to the porous membrane and the workpiece is immersed in an appropriate solidifying liquid; or a method in which the fluoropolymer and other optional components are dispersed in water, and the resulting dispersion is applied to the porous membrane using a roller. Alternatively, the stacking may be achieved by a method in which a film is formed from a fluoropolymer layer in advance, and then the film and the porous membrane are stacked by lamination, for example. Examples of forming a film from a fluoropolymer layer include a method in which the fluoropolymer and other optional components are dissolved or dispersed in a solvent, the solution or the dispersion is casted on a film having a flat surface, such as a polyester film or an aluminum film, and then the casted film is peeled off.

Examples of the solvent include amide solvents such as N-methyl-2-pyrrolidone; ketone solvents such as acetone; and cyclic ether solvents such as tetrahydrofuran. The fluoropolymer and other optional components may be dispersed in water.

The separator of the present invention can constitute a secondary battery together with a positive electrode, a negative electrode, and a non-aqueous electrolyte. Another aspect of the present invention is a secondary battery comprising the separator, a positive electrode, a negative electrode, and a non-aqueous electrolyte. The positive electrode, the negative electrode, and the non-aqueous electrolyte may be known ones usable for secondary batteries.

The secondary battery is particularly preferably a lithium secondary battery. The following will describe a representative structure of a lithium secondary battery as one example of the secondary battery of the present invention, but the secondary battery of the present invention should not be limited to this structure.

The positive electrode comprises a positive electrode mixture that includes a positive electrode active material, which is a material of the positive electrode, and a current collector.

The positive electrode active material may be any substance which allows electrochemical capture and extraction of lithium ions. The positive electrode active material is preferably a substance containing lithium and at least one transition metal. Examples thereof include lithium-transition metal complex oxides such as lithium-cobalt complex oxide, lithium-nickel complex oxide, and lithium-manganese complex oxide; and lithium-containing transition metal phosphate compounds.

The positive electrode mixture preferably further comprises a binding agent, a thickening agent, and an electrical conductor.

The binding agent may be any material that is safe against a solvent or an electrolyte to be used in the electrode production. Examples thereof include polyvinylidene fluoride, polytetrafluoroethylene, polyvinylidene fluoride-tetrafluoroethylene copolymers, polyvinylidene fluoride-hexafluoropropylene copolymers, polyvinylidene fluoride-tetrafluoroethylene-hexafluoropropylene copolymers, polyethylene, polypropylene, styrene-butadiene rubber, isoprene rubber, polybutadiene rubber, ethylene-acrylic acid copolymers, and ethylene-methacrylic acid copolymers.

Examples of the thickening agent include carboxymethyl cellulose, methyl cellulose, hydroxymethyl cellulose, ethyl cellulose, polyvinyl alcohol, oxidized starch, phosphorylated starch, and casein.

Examples of the electrical conductor include carbon materials such as graphite and carbon black.

The material of the current collector for positive electrodes may be a metal such as aluminum, titanium, or tantalum, or any alloy thereof. Preferred is aluminum or an alloy thereof.

The positive electrode can be produced by a usual method. For example, the positive electrode active material is mixed with the aforementioned binding agent, thickening agent, electrical conductor, solvent, and other components to form a slurry-like positive electrode mixture. This mixture is applied to a current collector. Then, the mixture is dried and press-densified.

The negative electrode comprises a negative electrode mixture that contains a negative electrode material, and a current collector.

Examples of the negative electrode material include pyrolyzed products of organic matters in various pyrolysis conditions; carbonaceous materials which allow capture and extraction of lithium, such as artificial graphite and natural graphite; metal oxide materials which allow capture and extraction of lithium, such as tin oxide and silicon oxide; lithium metal; and various lithium alloys. Two or more of these negative electrode materials may be used in admixture.

Preferable examples of the carbonaceous materials which allow capture and extraction of lithium include artificial graphite produced by high-temperature treatment on graphitizable pitch derived from various materials, refined natural graphite, and those produced by carbonizing these graphites whose surfaces are treated with pitch and organic matters.

The negative electrode mixture preferably further comprises a binding agent, a thickening agent, and an electrical conductor.

Examples of the binding agent include the same binding agents as those to be used in the positive electrode hereinabove.

Examples of the thickening agent include the same thickening agents as those to be used in the positive electrode hereinabove.

Examples of the electrical conductor for negative electrodes include metal materials such as copper and nickel; and carbon materials such as graphite and carbon black.

The material of the current collector for negative electrodes may be copper, nickel, or stainless steel, for example. Particularly preferred is copper foil because it is easy to process into a thin film and is inexpensive.

The negative electrode can be produced by a usual method. For example, the negative electrode material is mixed with the aforementioned binding agent, thickening agent, electrical conductor, solvent, and other components to form a slurry-like mixture. This mixture is applied to a current collector. Then, the mixture is dried and then press-densified.

The nonaqueous electrolyte may be a product of dissolving a known electrolyte salt in a known organic solvent for dissolving an electrolyte salt.

Any organic solvent for dissolving an electrolyte salt may be used. Examples thereof include hydrocarbon solvents such as propylene carbonate, ethylene carbonate, butylene carbonate, γ-butyrolactone, 1,2-dimethoxyethane, 1,2-diethoxyethane, dimethyl carbonate, diethyl carbonate, and ethyl methyl carbonate; and fluorine solvents such as fluoroethylene carbonate, fluoroether, and fluorinated carbonate. One or more of these may be used.

Examples of the electrolyte salt include LiClO₄, LiAsF₆, LiBF₄, LiPF₆, LiCl, LiBr, CH₃SO₃Li, CF₃SO₃Li, LiN(SO₂CF₃)₂, LiN(SO₂C₂F₅)₂, and cesium carbonate. Particularly preferred are LiPF₆, LiBF₄, LiN(SO₂CF₃)₂, LiN(SO₂C₂F₅)₂, and a combination of these because they can provide good cycling characteristics.

The concentration of the electrolyte salt is preferably not less than 0.8 mol/liter, and more preferably not less than 1.0 mol/liter. Though it depends on the organic solvent for dissolving an electrolyte salt, the upper limit thereof is usually 1.5 mol/liter.

The lithium secondary battery may have any shape. Examples thereof include a cylindrical type, a prismatic type, a laminate type, a coin type, and a large type. The shapes and the structures of the positive electrode, the negative electrode, and the separator can appropriately be modified in accordance with the shape of the battery within the range that does not deteriorate the effects of the present invention.

### EXAMPLES

The present invention will be described in detail below referring to, but not limited to, examples.

### Preparation Example 1

### Preparation of Fluoropolymer A

A 6-L autoclave was charged with 1.9 kg of pure water, and sufficiently purged with nitrogen. Then, 1.8 g of octafluorocyclobutane was added thereto, and the system temperature was maintained at 37° C. and the stirring rate was maintained at 580 rpm. Thereafter, 260 g of a TFE/VdF gas mixture at a TFE/VdF ratio of 5/95 mol % and 0.6 g of ethyl acetate were added to the autoclave, and then 2.8 g of a 50% by mass solution of di-n-propyl peroxydicarbonate in methanol was added to the autoclave to start the polymerization. Since the pressure in the system decreased with progression of the polymerization, a TFE/VdF gas mixture at a TFE/VdF ratio of 5/85 mol % was continuously supplied to maintain the pressure in the system at 1.3 MPaG. The mixture was continually stirred for 32 hours. The pressure was then released to the atmospheric pressure, and the reaction product was washed with water and dried. Thereby, 900 g of white powder of a fluoropolymer A was obtained.

The resulting fluoropolymer A had the following composition and properties.

VdF/TFE=83.0/17.0(mol %)

Number average molecular weight: 270000

Weight average molecular weight: 870000

### Preparation Example 2

### Preparation of Fluoropolymer B

A 6-L autoclave was charged with 1.9 kg of pure water, and sufficiently purged with nitrogen. Then, 1.8 g of octafluorocyclobutane was added thereto, and the system temperature was maintained at 37° C. and the stirring rate was maintained at 580 rpm. Thereafter, 260 g of a TFE/VdF gas mixture at a TFE/VdF ratio of 6/94 mol % and 0.6 g of ethyl acetate were added to the autoclave, and then 5.8 g of a 50% by mass solution of di-n-propyl peroxydicarbonate in methanol was added to the autoclave to start the polymerization. Since the pressure in the system decreased with progression of the polymerization, a TFE/VdF gas mixture at a TFE/VdF ratio of 5/85 mol % was continuously supplied to maintain the pressure in the system at 1.3 MPaG. The mixture was continually stirred for 32 hours. The pressure was then released to the atmospheric pressure, and the reaction product was washed with water and dried. Thereby, 900 g of white powder of a fluoropolymer B was obtained.

The resulting fluoropolymer B had the following composition and properties.

VdF/TFE=80.0/20.0(mol %)

Number average molecular weight: 130000 Weight average molecular weight: 290000

### Preparation Example 3

### Preparation of Fluoropolymer C

A 4-L autoclave was charged with 1.3 kg of pure water, and sufficiently purged with nitrogen. Then, 1.3 kg of octafluorocyclobutane was added thereto, and the system temperature was maintained at 37° C. and the stirring rate was maintained at 580 rpm. Thereafter, 200 g of a TFE/VdF gas mixture at a TFE/VdF ratio of 4/96 mol % and 0.4 g of ethyl acetate were added to the autoclave, and then 1 g of a 50% by mass solution of di-n-propyl peroxydicarbonate in methanol was added to the autoclave to start the polymerization. Since the pressure in the system decreased with progression of the polymerization, a TFE/VdF gas mixture at a TFE/VdF ratio of 13/87 mol % was continuously supplied to maintain the pressure in the system at 1.3 MPaG. The mixture was continually stirred for 17 hours. The pressure was then released to the atmospheric pressure, and the reaction product was washed with water and dried. Thereby, 190 g of white powder of a fluoropolymer C was obtained.

The resulting fluoropolymer C had the following composition and properties.

VdF/TFE=86.6/13.4(mol %)

Number average molecular weight: 274000

Weight average molecular weight: 768000

The compositions and molecular weights of the fluoropolymers were determined by the following methods.

<Polymer Composition>

Solutions of the polymers in DMSO were prepared and each subjected to ¹⁹F-NMR measurement using an NMR analyzing device (VNS 400 MHz, Agilent Technologies, Inc.). The following peak areas (A, B, C, and D) were measured in the ¹⁹F-NMR measurement, and the ratio between VdF and TFE was calculated.

A: area of peak from −86 ppm to −98 ppm

B: area of peak from −105 ppm to −118 ppm

C: area of peak from −119 ppm to −122 ppm

D: area of peak from −122 ppm to −126 ppm

VdF: (4A+2B)/(4A+3B+2C+2D)×100 (mol %)

TFE: (B+2C+2D)/(4A+3B+2C+2D)×100 (mol %)

### <Number Average Molecular Weight and Weight Average Molecular Weight>

The molecular weights were determined by gel permeation chromatography (GPC). Specifically, these values were calculated from the data (reference: polystyrene) measured using HLC-8320GPC (Tosoh Corporation), columns (three Super AWM-H columns connected in series), and a dimethylformamide (DMF) solvent.

For the fluoropolymers A to C prepared in Preparation Examples 1 to 3, the following measurement and evaluation were performed. Table 1 shows the results.

### <Electrolyte Swellability>

A 5% by mass solution of each fluoropolymer in NMP was prepared and applied to aluminum foil by cast-coating. Thereafter, the coating was dried with an air-blowing incubator (Yamato Scientific Co., Ltd.) at 120° C., thereby completely evaporating NMP. As a result, a 10-μm-thick strip-like cast film was obtained.

The resulting cast film was cut out into a size of 5×20 mm and put into a sample bottle that contained an electrolyte (a 1 M solution of LiPF₆ dissolved in a solvent mixture of ethylene carbonate/ethylmethyl carbonate=3/7 (ratio by volume)). Then, the sample was left to stand at 25° C. for 24 hours or at 60° C. for 24 hours. The rate of increase (%) in mass of the sample before and after the putting was calculated.

### <Ion Conductivity>

A 5% by mass solution of each fluoropolymer in NMP was prepared and applied to aluminum foil by cast-coating. Thereafter, the coating was dried with an air-blowing incubator (Yamato Scientific Co., Ltd.) at 120° C., thereby completely evaporating NMP. As a result, a 10-μm-thick strip-like cast film was obtained.

The resulting cast film was immersed in an electrolyte (a 1 M solution of LiPF₆ dissolved in a solvent mixture of ethylene carbonate/ethylmethyl carbonate=3/7) for 10 minutes. The film was then sandwiched between SUS electrodes and connected to a galvano-potentiostat (Spectrum analyzer: Model 1260, Solartron analytical; Potentiostat: Model 1287, Solartron analytical). The ion conductivity (S/cm) was determined by an alternating current impedance method (frequency: 10⁻³ to 10⁶ Hz, AC voltage: 10 mV).

<Affinity with Electrolyte>

A 5% by mass solution of each fluoropolymer in NMP was prepared and applied to aluminum foil by cast-coating. Thereafter, the coating was dried with an air-blowing incubator (Yamato Scientific Co., Ltd.) at 120° C., thereby completely evaporating NMP. As a result, a 10-μm-thick strip-like cast film was obtained.

Then, 2 μL of an electrolyte (a 1 M solution of LiPF₆ dissolved in a solvent mixture of ethylene carbonate/ethylmethyl carbonate=3/7) was dropped onto the resulting cast film, and 61 seconds later, the static contact angle was measured using an automatic contact angle meter Drop Master 701. The smaller the contact angle was, the better the affinity with the electrolyte is.

TABLE 1

| | | Preparation | Preparation | Preparation |
|---|---|---|---|---|
| | | Example 1 | Example 2 | Example 3 |
| Electrolyte | 25° C. | 20 | 20 | 20 |
| swellability [wt %] | 60° C. | 60 | Dissolved | 40 |
| Ion conductivity | | 3 × 10⁻⁴ | 3 × 10⁻⁴ | 3 × 10⁻⁴ |
| [S/cm] | | | | |
| Contact angle [°] | | 18 | 18 | 19 |

1. A separator comprising
a layer comprising a fluoropolymer that includes a polymer unit based on vinylidene fluoride and a polymer unit based on tetrafluoroethylene; and
a porous membrane,
the fluoropolymer including 80.0 to 89.0 mol % of the polymer unit based on vinylidene fluoride in all the polymer units, and
the fluoropolymer having a weight average molecular weight of 50000 to 2000000.

2. The separator according to claim 1,
wherein the porous membrane comprises at least one resin selected from polyethylene, polypropylene, and polyimide.

3. The separator according to claim 1,
wherein the layer comprising the fluoropolymer further comprises polyvinylidene fluoride.

4. A secondary battery comprising
the separator according to claim 1, a positive electrode, a negative electrode, and a non-aqueous electrolyte.
